(19) United States
(12) Patent Application Publication
(10) Pub. No.: US 2026/0021477 A1
(43) Pub. Date: Jan. 22, 2026

(54) METHOD FOR ELECTROCATALYTIC ACTIVATION OF MXENE AND MXENES MADE THEREFROM

(71) Applicant: Trustees of Dartmouth College, Hanover, NH (US)

(72) Inventors: William J. SCHEIDELER, Hanover, NH (US); Anand P. TIWARI, Hanover, NH (US)

(21) Appl. No.: 19/124,495

(22) PCT Filed: Oct. 26, 2023
(86) PCT No.: PCT/US2023/077930

§ 371 Date: Apr. 25, 2025

Related U.S. Application Data
(60) Provisional application No. 63/419,685, filed on Oct. 26, 2022.

(51) Int. Cl. B01J 27/04; B01J 27/24; B01J 35/33; B01J 37/08

(52) U.S. Cl. CPC B01J 27/04; B01J 27/24; B01J 35/33; B01J 37/08

(57) ABSTRACT

A methodology for non-metallic (anions; nitrogen, sulfur) electron donor incorporation in a MXene material by annealing of MXene in a furnace with a solid sulfur/nitrogen precursor compound (thiourea) under flowing pure nitrogen gas and hydrogen gas. MXenes are a family of layered 2D carbide materials based on a structure similar to M₃C₂Tₓ where M is a metal such as titanium and T represents surface termination groups such as oxygen, fluorine, etc.

### CROSS REFERENCE TO RELATED APPLICATION

This application claims the benefit of priority to U.S. Provisional Application No. 63/419,685, filed on Oct. 26, 2022, the disclosure of which is incorporated herein by reference.

### BACKGROUND OF THE DISCLOSURE

Hydrogen (H₂) is considered a promising clean, carbon-neutral, and renewable energy resource when produced by electrolyzing water and consumed in hydrogen fuel cells to produce electricity with water as the sole product. Commercial electrolyzers utilize noble metal based Pt/C electrocatalysts for hydrogen production via efficient electrocatalytic hydrogen evolution reaction (HER), however, the practical applications of Pt-based materials are restricted because these materials are expensive and scarce, restricting large-scale production. Thus, great research efforts have been devoted to replacing expensive and noble-metal based electrocatalysts with earth abundant materials for efficient H₂ production and utilization. In recent years, numerous alternative electrocatalysts including transition metal based alloys, chalcogenides, nitrides, and phosphides have been investigated to replace noble metal electrocatalysts, offering promise given their similar d-band states to those of Pt. Nevertheless, the electrocatalytic HER performance of most alternatives to noble metal-based electrocatalysts remain insufficient for industrial applications in terms of stability and activity.

MXenes, a new class of 2D transition metal carbides/nitrides, feature exceptional properties, including excellent electronic conductivity with efficient charge transport, and a unique layered structure predicted to make them promising electrocatalysts. MXenes consist of catalytically active basal planes with exposed metal sites that may be functionalized with a high surface coverage of termination groups (T_{X}=O, OH, and F) that offer electrocatalytic active sites for hydrogen evolution. The high electronic conductivity of MXenes can facilitate fast electron transport to electrochemically active sites, ensuring improved kinetics for electrochemical HER activity. Despite these theoretical advantages, Ti, V and Mo based MXenes experimentally studied as electrocatalysts for HER have shown poor electrocatalytic performance with higher overpotential (>600 mV). In order to improve the electrocatalytic properties of MXenes, modifications have been made to the termination functional groups (O, OH, and F) by using various etchants. Recent work has achieved efficient HER activity by dispersing single-atom-catalysts (Pt, and Ru) into the vacancy sites of MXenes to form noble metal and carbon bonds. This report of electrocatalytic activity despite the very small concentrations of single-atom-catalyst (Pt, and Ru) on the MXene surface, shows the possibility of improving electrocatalytic activity by tunable interfacial functionalization and/or modification of MXenes. In this regard, metallic electron donors (Fe, Ni, and Co) have been predicted to be potential dopants to improve the electrocatalytic activity of MXenes by donating electrons to O atoms, reducing charge transfer from H to O. However, stability of metallic electron donor doped MXenes is poor because of dissociation and oxide formation on the surface during electrocatalytic activity in acidic electrolytes. Thus, the use of nonmetallic atoms (anions) can be an appropriate way to achieve both highly active and highly stable MXene electrocatalysts. In this respect, nitrogen (N) and phosphorus (P) doped Ti and V-based MXenes have been reported with efficient electrocatalytic activity for HER. However, N or P doped MXene leads to the oxidation of the transition metal surface and causes activity degradation during electrocatalytic activity.

### SUMMARY OF THE DISCLOSURE

A methodology for non-metallic (anions; nitrogen, sulfur) electron donor incorporation in a MXene material by annealing of MXene in a furnace with a solid sulfur/nitrogen precursor compound (thiourea) under flowing pure nitrogen gas and hydrogen gas. MXenes are a family of layered 2D carbide materials based on a structure similar to M₃C₂Tₓ where M is a metal such as titanium and T represents surface termination groups such as oxygen, fluorine, etc. The embodiments disclosed herein provide greater control of highly stable surface termination groups of MXenes to enhance their electrochemical performance. X-ray photoelectron spectroscopy (XPS) characterization of the MXene powder indicates that the material has been chemically modified at the surface. Analysis of the XPS spectra suggests a formation of new chemical bond between MXene components (Ti and C) and incorporated anions (sulfur and nitrogen) with atomic % ranging from 2%-4% (sulfur) and 5%-15% (for nitrogen).

### BRIEF DESCRIPTION OF THE FIGURES

For a fuller understanding of the nature and objects of the disclosure, reference should be made to the following detailed description taken in conjunction with the accompanying figures.

FIG. 1. Synthesis and structural characterization of the pristine Ti₃C₂T_{X} and anion incorporated N—S-Ti₃C₂T_{X} MXene. (a) Schematic illustration of the procedures for preparing the pristine-Ti₃C₂T_{X} and anion incorporated Ti₃C₂T_{X} MXene. b) XRD patterns of pristine-Ti₃C₂T_{X} and co-doped Ti₃C₂T_{X} MXene. TEM images of (c) pristine-Ti₃C₂T_{X}, and (f) co-doped-Ti₃C₂T_{X} MXene. SEM images of (d) pristine Ti₃C₂T_{X}, and (g) co-doped-Ti₃C₂T_{X} MXene. AFM images of (e) pristine-Ti₃C₂T_{X}, and (h) co-doped-Ti₃C₂T_{X} MXene.

FIG. 2. XPS analysis. (a, b, and d-f) Reaction temperature-dependent changes in chemical composition of pristine-Ti₃C₂T_{X} vs. Ti₃C₂T_{X} treated at 300, 500, and 700° C. a) survey spectra of pristine-Ti₃C₂T_{X} and all synthesized samples after heat treatment, b) Ti 2p core level spectra, c) variation of atomic N and S composition in N is, and S 2p core level spectra as a function of reaction temperature, d) C 1s core level spectra, e) N 1s core level spectra, and f) S 2p core level spectra.

FIG. 3. Electrocatalytic performance of pristine and doped MXene. a) Linear sweep voltammetry of as-synthesized samples. b) Corresponding Tafel slopes. c) Calculated turnover frequencies (TOFs) for H₂ per active site of the as-synthesized samples. d) Plots to determine Cal of as-synthesized samples. e) Nyquist plots of different as-synthesized samples at an overpotential of 275 mV versus NHE (inset shows the equivalent circuit). f) Chronoamperometry measurement (j vs. t) for the co-doped-Ti₃C₂T_{X} sample. All data were acquired in 0.5 M H₂SO₄.

FIG. 4. DFT calculation results. DFT-optimized structures of (a) pristine-Ti₃C₂T_{X}, (b) S-Ti₃C₂T_{X}, (c) N-Ti₃C₂T_{X}. Two different possible optimal configuration of N—S-Ti₃C₂T_{X} (d) S incorporated inside the lattice, (e) S absorbed on the surface of Ti₃C₂T_{X}. (f) Hydrogen adsorption free energy (ΔG_{H}*) values on pristine-Ti₃C₂T_{X}, S-Ti₃C₂T_{X}, N-Ti₃C₂T_{X}, and N—S-Ti₃C₂T_{X}-H.

FIG. 5. XRD patterns of Ti₃C₂T_{X}, and Ti₃C₂T_{X}(9.8% N, 4.8% S) samples after exfoliation.

FIG. 6. HRTEM images of a) pristine-Ti₃C₂T_{X}, and b) Ti₃C₂T_{X}(9.8% N, 4.8% S).

FIG. 7. Magnified SEM images of (a) Ti₃C₂T_{X} MXene, and (b) co-doped-Ti₃C₂T_{X} MXene.

FIG. 8. Cyclic voltammetry of a) pristine-Ti₃C₂Tₓ, and b) Ti₃C₂T_{X} (0.7% N), c) Ti₃C₂T_{X} (5.8% N), d) Ti₃C₂T_{X} (8.0% N, 2.4% S), e) Ti₃C₂T_{X} (14.6% N, 3.4% S), and f) Ti₃C₂T_{X}(9.8% N, 4.8% S) with different scan rates.

FIG. 9. LSV curves of as-prepared pristine and N, and S co-doped Ti₃C₂T_{X} MXene normalized by ECSA.

FIG. 10. LSV curves for Ti₃C₂T_{X} (9.8% N, 4.8% S) before and after 60 h stability test.

FIG. 11. XPS of Ti₃C₂T_{X} (9.8% N, 4.8% S) before and after stability test.

FIG. 12. XRD of N, and S co-doped Ti₃C₂T_{X} before and after stability test.

FIG. 13. Possible dopant locations investigated with DFT. (a) scheme of Ti₃C₂Tx with all possible dopant locations shown. (b) top view of Ti₃C₂Tx showing locations of surface adsorption (SA) investigated.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure.

As used herein, unless otherwise indicated, “about”, “substantially”, or “the like”, when used in connection with a measurable variable (such as, for example, a parameter, an amount, a temporal duration, or the like) or a list of alternatives, is meant to encompass variations of and from the specified value including, but not limited to, those within experimental error (which can be determined by, e.g., a given data set, an art accepted standard, etc. and/or with, e.g., a given confidence interval (e.g., 90%, 95%, or more confidence interval from the mean), such as, for example, variations of +/−10% or less, +/−5% or less, +/−1% or less, and +/−0.1% or less of and from the specified value), insofar such variations in a variable and/or variations in the alternatives are appropriate to perform in the instant disclosure. As used herein, the term “about” may mean that the amount or value in question is the exact value or a value that provides equivalent results or effects as recited in the claims or taught herein. That is, it is understood that amounts, sizes, compositions, parameters, and other quantities and characteristics are not and need not be exact, but may be approximate and/or larger or smaller, as desired, reflecting tolerances, conversion factors, rounding off, measurement error, or the like, or other factors known to those of skill in the art such that equivalent results or effects are obtained. In general, an amount, size, composition, parameter, or other quantity or characteristic, or alternative is “about” or “the like,” whether or not expressly stated to be such. It is understood that where “about,” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5%, but also, unless otherwise stated, include individual values (e.g., 1%, 2%, 3%, and 4%) and the sub-ranges (e.g., 0.5% to 1.1%, 0.5% to 2.4%, 0.5% to 3.2%, and 0.5% to 4.4%, and other possible sub-ranges) within the indicated range. It is also understood (as presented above) that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about”, it will be understood that the particular value forms a further disclosure. For example, if the value “about 10” is disclosed, then “10” is also disclosed.

As used herein, the terms “including,” “containing,” and “comprising” are used in their open, non-limiting sense.

As used in this disclosure, the singular forms include the plural forms and vice versa unless the context clearly indicates otherwise.

The articles “a” and “an” are used in this disclosure to refer to one or more than one (i.e., to at least one) of the grammatical object of the article. By way of example, “an element” means one element or more than one element.

As used herein, unless otherwise stated or indicated, “s” or “sec” refers to second(s), “m” or “min” refers to minute(s), and “h” or “hr” refers to hour(s).

The present disclosure provides a methodology for non-metallic (anions; nitrogen, sulfur) electron donor incorporation in a MXene material by annealing of MXene in a furnace with a solid sulfur/nitrogen precursor compound (thiourea) under flowing pure nitrogen gas and hydrogen gas. MXenes are a family of layered 2D carbide materials based on a structure similar to M₃C₂Tₓ where M is a metal such as titanium and T represents surface termination groups such as oxygen, fluorine, etc. This modification allows greater control of highly stable surface termination groups of MXenes to enhance their electrochemical performance. The x-ray photoelectron spectroscopy (XPS) characterization of the MXene powder supports the claim that the material has been chemically modified at the surface. The analysis of the XPS spectra suggests a formation of new chemical bond between MXene components (Ti and C) and incorporated anions (sulfur and nitrogen) with atomic % ranging from 2%-4% (sulfur) and 5%-15% (for nitrogen).

In an aspect, the present disclosure provides MXene compositions. The MXene compositions provide modified MXenes having a desirable amount of N and S. The N and S may be in the basal layer of the MXene.

The MXene may have the following formula: M₃C₂Tₓ, wherein M is a metal and T is a surface termination group chosen from —O, —OH, —F, —I, and —Cl. The MXene may comprise various metals. Non-limiting examples of metals include Ti, Nb, W, Y, Zr, Hf, Mo, V, TiV, MoV, NbTi, NbZr, MoTi, and the like, and any combination thereof. In various examples, the metal is Ti.

The MXene may comprise various amounts of N and S. N and S is bonded at least to a portion of the metal atoms and/or at least a portion of the carbon atoms. For example, the bonded S may account for 1 to 8% (e.g., 2 to 7.5% or 1 to 7%) of the atoms in the MXene, including all 0.01% values and ranges therebetween (e.g., 2 to 4%). For example, the bonded N is 5 to 25% of the atoms in the MXene, including all 0.01% values and ranges therebetween (e.g., 5 to 15%).

The characterization by x-ray diffraction (XRD) shows changes in the interlayer spacing and crystallinity of Ti₃C₂Tₓ, confirms structural changes in the bulk of the material after incorporation of the anions (sulfur and nitrogen) atoms into Ti₃C₂Tₓ.

Morphological characterization by transmission electron microscopy suggests that after that incorporation of sulfur and nitrogen atoms in the MXene, the surface morphology is changed from the planar nanosheet surface of the pure MXene to a surface morphology decorated with hexagonal nanoplates.

The MXenes of the present disclosure may have one or more desirable features. For example, the MXenes may have enhanced durability relative to other MXenes (e.g., MXenes without the same amount of bonded N and bonded S). For example, the MXenes may have up to 60 hours of continuous operation with performance decay. The MXenes may also have desirable hydrogen evolution reaction (HER) activity. For example, MXenes of the present disclosure may have higher electrocatalytic activities than reported modified Ti-based MXene (Ti₂CT_{X}; overpotential: 609 mV at 10 mA/cm²; Tafel Slope: 124 mV/dec), and Mo-based MXene (Mo₂CT_{X}; overpotential 283 mV; Tafel slope: 82 mV/dec. Experimental results show 3 times lower over potential (200 mV vs. 600 mV) and 6 times higher electrocatalytic active area (55 mF/cm² vs. 9 mF/cm²) for MXene materials after structural and chemical modification by incorporation of additional anions (sulfur and nitrogen) into the MXene structure.

One advantage of the MXenes of present disclosure is that they can overcome the limitations of the poor intrinsic chemical activity and the limited active site densities of traditional pure Ti₃C₂Tₓ MXenes. The interfacial chemical co-doping with anions, (a process called herein ‘sulfonitridation’) through heat-treatment with thiourea as the simultaneous source of both nitrogen and sulfur improves the chemical activity and active site densities. One result observed is that Ti₃C₂Tₓ MXenes treated with this method at 500° C. shows the highest concentration of Ti—N, Ti—S, C—S, and CN bonds, and exhibits the smallest overpotential of −260 mV at 10 mA cm⁻² in 0.5 m H₂SO₄. This primary metric of the efficiency for HER is three times lower than pristine Ti₃C₂Tₓ (−770 mV at 10 mA cm⁻²). This shows the potential of the present method to enhance MXenes' catalytic activity. This is a generally applicable strategy for electrocatalytically accelerating hydrogen evolution activity of Ti₃C₂Tₓ MXenes by simultaneous interfacial doping and structural modifications. This method could offer the possibility of manipulating the catalytic performance of various other MXenes as well.

Another advantage of the present disclosure is its ability to enhance the stability and electrochemical activity of MXenes. This can extend to various current applications of MXenes in catalysis and energy storage. For example, the composition of the present disclosure can be applied to electrode materials in renewable energy devices such as fuel cells, metal air batteries, and for water electrolysis.

In an aspect, the present disclosure provides devices comprising a MXene of the present disclosure.

In various examples, the device is an energy storage device, a sensor, an electrode, an electrolyzer, a water electrolysis device, or device comprising one or more of any one of the foregoing. For example, the energy storage device may be a battery, fuel cell, or supercapacitor. The batteries may be, Li-air batteries, metal-air batteries, S-batteries, Na-ion batteries, or the like.

The present disclosure also provides a method to control the atomic % of sulfur and nitrogen incorporation into MXene materials (e.g. TiCxT) by modulation of the thermal annealing time and temperature. In an embodiment, the annealing time was approximately 1 hour-3 hours. In embodiments, the annealing temperature was 300-700° C.

In various examples, the method comprises contacting or exposing an unmodified MXene (e.g., a MXene without S or N bonded to the metal and/or carbon atoms, such as, for example, a MXene having the formula M₃C₂Tₓ, with the variables as defined herein) with a sulfur source and a nitrogen source at a temperature of 300 to 700° C., including all integer temperature values and ranges therebetween. Varying temperature may be used to control the amount of N versus S present. For example, at a lower temperature (e.g., 300° C.) S is doped prominently; however, at higher temperatures (e.g., 700° C.) N is doped. 500° C. may be appropriate temperature for co-doping of S, and N.

The method may further comprise contacting or subjecting the MXene with a stream or flow of gas. For example, the gas may comprise N₂ and H₂ (e.g., 95% N₂ and 5% H₂).

Various sulfur sources and nitrogen sources may be sued. For example, the sulfur source may be the same or different than the nitrogen source. The nitrogen and/or sulfur source may be an organosulfur compound. For example, the organosulfur compound may be a thiourea, a thiol, or a thione. For example, the thiourea is thiourea.

The steps of the method described in the various embodiments and examples disclosed herein are sufficient to carry out the methods of the present invention. Thus, in an embodiment, the method consists essentially of a combination of the steps of the methods disclosed herein. In another embodiment, the method consists of such steps.

The following Statements provide various examples of the present disclosure.

Statement 1. A MXene composition, comprising: a MXene with a formula of M₃C₂Tₓ, wherein M is a metal or metal alloy and T is a surface termination group chosen from —O, —OH, —F, —I, and —Cl, and, wherein at least a portion of M and C atoms are bonded to S or N and the amount of S is at least 1% and the amount of N is at least 5%, wherein the percent S and percent N are relative to the total percentage of atoms in the atoms in the MXene.

Statement 2. A MXene composition according to Statement 1, wherein M is Ti, Nb, W, Y, Zr, Hf, Mo, V, TiV, MoV, NbTi, NbZr, MoTi, or any combination thereof.

Statement 3. A MXene composition according to Statement 1 or Statement 2, wherein M is Ti.

Statement 4. A MXene composition according to any one of the preceding Statements, wherein the bonded S is 1-7% of the atoms in the MXene.

Statement 5. A MXene composition according to any one of the preceding Statements, wherein the bonded S is 2-4% of the atoms in the MXene.

Statement 6. A MXene composition according to any one of the preceding Statements, wherein the bonded N is 5-25% of the atoms in the MXene.

Statement 7. A MXene composition according to any one of the preceding Statements, wherein the bonded N is 5-15% of the atoms in the MXene.

Statement 8. The MXene composition according to any one of the preceding Statements, wherein the MXene has a surface comprising a hexagonal-nanoplate-decorated nanosheet morphology.

Statement 9. The MXene composition according to any one of the preceding Statements, wherein the bonded S and N are located in the basal plane of the MXene.

Statement 10. A device comprising a MXene composition according to any one of the preceding Statements.

Statement 11. A device according to Statement 10, wherein the device is an energy storage device.

Statement 12. A device according to Statement 10 or Statement 11, wherein the device is a battery, supercapacitor, or fuel cell.

Statement 13. A device according to Statement 10, wherein the device is an electrode or comprises an electrode.

Statement 14. A device according to Statement 10, wherein the device is a sensor.

Statement 15. A method of making a MXene composition according to any one of Statements 1 to 9, comprising exposing an unmodified MXene with a formula of M₃C₂Tₓ to a sulfur source and a nitrogen source at a temperature of 300 to 700° C.

Statement 16. A method according to Statement 15, further comprising subjecting the MXene composition to a flow comprising nitrogen gas and hydrogen gas.

Statement 17. A method according to Statement 15 or Statement 16, wherein the sulfur source and the nitrogen source are the same.

Statement 18. A method according to any one of Statements 15 to 17, wherein the sulfur source and the nitrogen source are organosulfur compounds.

Statement 19. A method according to Statement 18, wherein the organosulfur compound is chosen from a thiourea, a thiol, or a thione.

Statement 20. A method according to Statement 18, wherein the thiourea is thiourea.

The following sample claims are presented to illustrate the present disclosure. They are not intended to be limiting in any matter.

### EXAMPLE

The following provides examples of methods of the present disclosure.

Tunable co-doping (doping with two anion atoms) with surface structural modification could help prevent oxidation of transition metal surface and resolve the stability issues. Moreover, co-doping of two anions in MXenes can modulate local charge density to reduce the kinetic energy adsorption barrier (ΔG_{H*}) for water dissociation during HER.

MXenes have attracted attention as promising electrocatalysts for performing the hydrogen evolution reaction (HER). However, the poor intrinsic kinetics and inadequate density of active sites restrict MXenes as viable electrocatalysts for efficient hydrogen production. Herein, these hindrances are overcome via tunable doping of anion atoms as electron donors in titanium carbide (Ti₃C₂T_{X}) MXene. By engineering the co-doping of nitrogen and sulfur anions, efficient electrocatalytic activity was engineered through synergistic chemical and structural changes. The modified MXene offered a desirable concentration of Ti—S and Ti—N bonds at the surface of hexagonal nanoplate-decorated nanosheets, resulting in an low overpotential of 260 mV and a Tafel slope of 85 mV/dec in acidic medium, which is improved 3× over that of pristine MXene (overpotential of 770 mV). This modified Ti₃C₂T_{X} catalyst also displays superior durability compared with other earth-abundant catalysts, showing operation for 60 hours of continuous hydrogen evolution without any decay in its performance. The enhanced electrocatalytic activity of anion co-doped Ti₃C₂T_{X} MXene is attributed to manipulation of the electronic structure through synergistic N and S bonding, which promotes balanced adsorption/desorption of the intermediate hydrogen H* by lowering the Gibbs free energy (ΔG_{H*}=−0.07 eV). The strategy described herein to improve electrocatalytic activity of Ti₃C₂T_{X} by anion engineering may be used to enhance the electrocatalytic activity of numerous MXenes as well as other high surface area 2D materials.

Described herein is an in-situ tunable chemical co-doping and structural modification of the surface of 2D titanium carbide (Ti₃C₂T_{X}) MXene with anion (N and S) electron donor atoms by thermal annealing with thiourea. N—S-doped Ti₃C₂T_{X} (labeled N—S-Ti₃C₂T_{X}) are synthesized by nitrosulfurization in the presence of ammonia (NH₃) and hydrogen disulfide (H₂S) derived from thiourea, which can generate chemical defects or vacancies in Ti₃C₂T_{X}, forming chemically homogeneous N—S-Ti₃C₂T_{X} nanosheets. Through this process, substitution/doping of nitrogen and sulfur takes place at the MXene basal plane at concentrations ranging from 2%-4% (Sulfur), and 5%-15% (Nitrogen). It was found that the surface structure of the Ti₃C₂T_{X} is transformed from planar nanosheets to a surface comprised of hexagonal-nanoplate-decorated nanosheets after the N and S co-doping. The modified Ti₃C₂T_{X} offers an optimal concentration of Ti—S and Ti—N bonds as well as a low overpotential of 260 mV and a Tafel slope of 85 mV/dec to gain a current density of 10 mA/cm² in an acidic medium, which is three times lower than that of pristine Ti₃C₂T_{X} (overpotential: −770 mV, and Tafel slope: 247 mV/dec). This modified Ti₃C₂T_{X} catalyst also displayed superior durability: up to 60 hours of continuous operation without any decay in performance. These results are the first attempt at tunable co-doping of Ti₃C₂T_{X} MXene electrocatalysts, yielding electrocatalytic performances for HER with better stability than previously reported Ti-based, V-based and Mo-based MXenes. This work shows that the surface structure modification with tunable co-doping of anion electron donors is an effective strategy to design active and stable electrocatalysts for HER, and can be applicable in other MXene based materials for efficient HER.

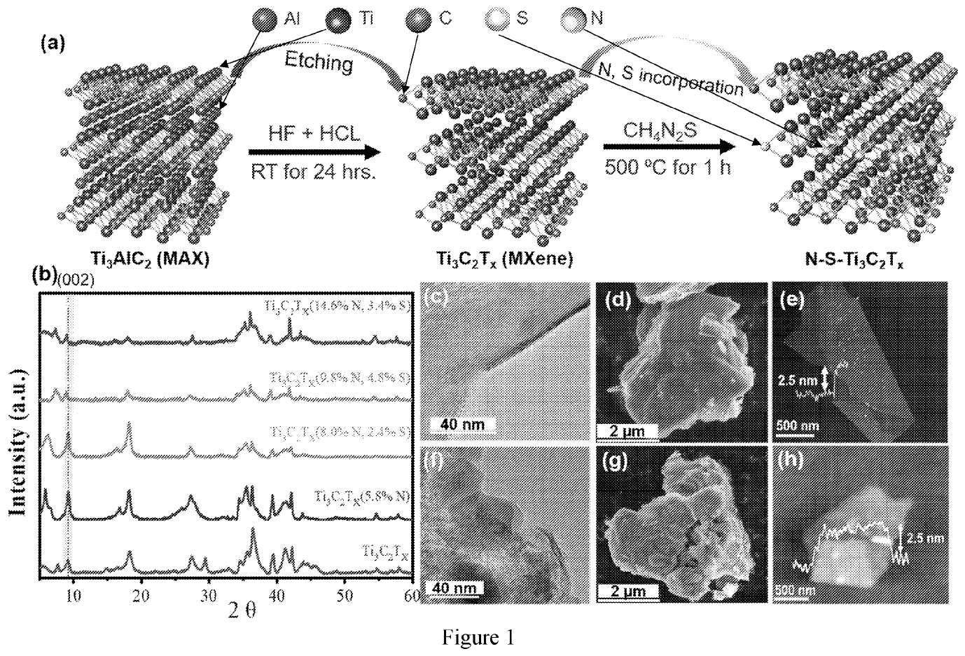

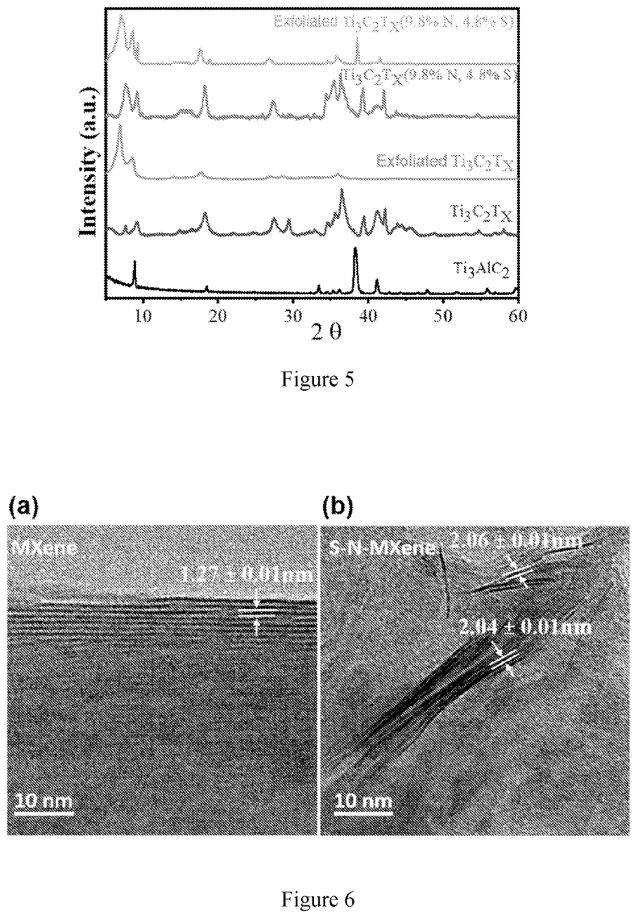

Morphological and structural characteristics of N—S-Doped Ti₃C₂T_{X}. The process for anionic (N and S) incorporation was applied to a starting material of Ti₃C₂T_{X}, a multilayered MXene synthesized by selective etching of Al by HF and HCl from the MAX phase precursor, Ti₃AlC₂ (shown in schematic illustration shown in FIG. 1 (a)). Anionic incorporation to multilayered MXene was conducted by annealing with thiourea (details of these synthetic methods are provided in the experimental section). The annealing temperature and atmosphere was varied from 300° C. to 700° C., under gas flow (N₂, and N₂+5% H₂) to control the degree of anion doping in the N—S-Ti₃C₂T_{X} MXene. X-ray diffraction (XRD) was used to determine the crystal structure of the as-prepared N—S-Ti₃C₂T_{X}. FIG. 1 (b) shows XRD spectra of each sample. The diffraction pattern of pristine Ti₃C₂T_{X} showed the broad (002) peak at 9.05°, which revealed a c-lattice parameter (c-LP) of 13.7 Å, which is similar to reported values for Ti₃C₂T_{X} MXene. Additionally, the peak at 7.740 corresponded to intercalated MXene with water molecules. After doping, it was observed that the (002) c-lattice spacing peak shifted downward to 8.7°, which corresponds to a c-LP of 21.03 Å for the 500° C. annealed in N₂+5% H₂ atmosphere co-doped Ti₃C₂T_{X} sample, revealing the higher interlayer spacing after N and S incorporation. However, there was no shift in the (002) peak observed in the Ti₃C₂T_{X} annealed at 300° C. in N₂+5% H₂ atmosphere, reflecting the limited doping at lower annealing temperatures. Higher temperature (700° C.) annealed in N₂+5% H₂ atmosphere samples also showed lower shifts of the (002) peak relative to the 500° C. co-doped samples, which is consistent with the results from XPS that showed only N-doping in this sample. In addition, it is noted that no impurity diffraction peaks from thiourea were observed, confirming purity of the doped MXene samples. After exfoliation, XRD measurements showed further shifts in the (002) peaks, confirming that samples with single/few layers of N and S co-doped-Ti₃C₂T_{X} were synthesized (shown in supporting information FIG. 5).

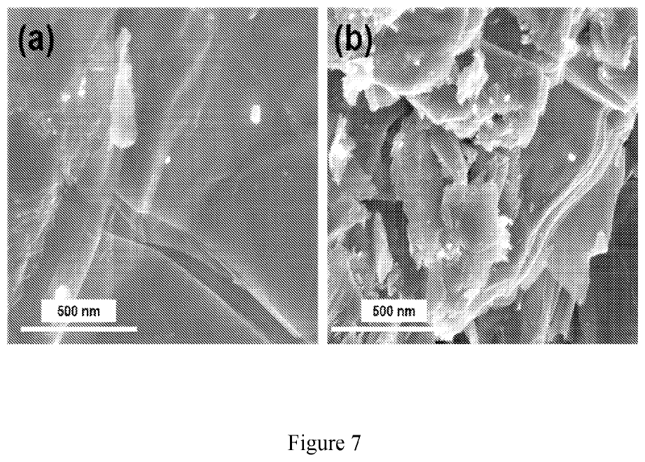

Electron microscopy showed a significant change to the microstructure after N and S incorporation, visible in the morphologies of pristine and doped Ti₃C₂T_{X} shown in FIGS. 1c and 1f The layered structure was observed in pristine-Ti₃C₂T_{X} as well as in the 500° C., N₂/H₂ annealed N, S-doped Ti₃C₂T_{X}. Moreover, unlike pristine Ti₃C₂T_{X} (FIG. 1 (c)), homogeneous hexagonal nanoplates were observed on the surface of the anion incorporated Ti₃C₂T_{X} sample, revealing formation of Ti—S and/or Ti—N, and C—N and/or C—S on the basal planes, shown in Figure if Because most sulfides and nitrides of titanium and carbon have hexagonal crystal structures, the morphology of hexagonal nanoplates reported here is presumed to form after N and S co-doping into the MXene structures. Moreover, TEM images showed a significant change in the interlayer spacing from pristine Ti₃C₂T_{X} (1.27) to N and S co-doped Ti₃C₂T_{X} (2.04 nm), which agrees with the XRD results (shown in FIG. 6). To gain insight into the change in the surface morphology, scanning electron microscopy (SEM) analysis was performed. The pristine Ti₃C₂T_{X} showed distinct flat multilayered structures (FIG. 1d). By SEM, it was observed that the co-doped Ti₃C₂T_{X} sample (500° C. in N₂+5% H₂) showed wrinkles of its multilayered structure (FIG. 1g, and FIG. 7), which occurred due to formation of hexagonal nanoplates on the surface, agreeing with TEM analysis. The thickness of exfoliated single layered pristine and doped Ti₃C₂T_{X} was observed by atomic force microscopy (AFM) (FIG. 1e and 1h). AFM showed that the Ti₃C₂T_{X} flakes had a thicknesses of approximately 2.5 nm and that the flake size was a few microns across (FIG. 1e). However, the thickness of co-doped Ti₃C₂T_{X} flakes annealed at 500° C. in N₂+5% H₂ atmosphere was similar to that of pristine Ti₃C₂T_{X} flakes (FIG. 1h) with greater surface roughness than pristine Ti₃C₂T_{X} flakes, indicating N and S incorporation changes the surface morphology but not the thickness of single layered flakes.

Chemical composition of N—S-Doped Ti₃C₂T_{X}. The surface chemical composition and elemental valence state of the pristine Ti₃C₂T_{X} and anion incorporated N—S-Ti₃C₂T_{X} MXene were analyzed by X-ray photoelectron spectroscopy (XPS). An increase in N doping from 5.84 at. % to 14.62 at. % was observed as the annealing temperature increased from 300 to 700° C. under N₂/H₂ flow. However, S content increased from 0 at. % at 300° C. to 4.83 at. % at 500° C., and then decreased to 3.42 at. % for 700° C. annealing. Only a small degree (0.7 at %) of N-doping occurred at 300° C. with only N₂ flowing, confirming N₂-flow alone is not sufficient to reduce thiourea for N or S doping at 300° C. Instead, flowing N₂+₅% H₂ is favorable to reduce thiourea, enabling S and N co-incorporation at 500° C. However, at higher annealing temperatures (at 700° C.), S atoms may bond with H₂ (to form H₂S gas) more prominently than MXene, resulting in lower S incorporation into the MXene. Atomic ratios of N and S with the function of temperature are summarized in Table 1.

TABLE 1
Summary of the N and S atomic percentage
as a function of reaction temperature.

| | | Flowing | N | S |
|---|---|---|---|---|
| Samples | Temperature | gas | atomic % | atomic % |
| Ti₃C₂T_{X} (0.7% N) | 300° C. | N₂ | 0.7 | 0.00 |
| Ti₃C₂T_{X} (5.8% N) | 300° C. | N₂ + 5% H₂ | 5.8 | 0.00 |
| Ti₃C₂T_{X} (8.0% N, | 500° C. | N₂ | 8.0 | 2.4 |
| 2.4% S) | | | | |
| Ti₃C₂T_{X} (9.8% N, | 500° C. | N₂ + 5% H₂ | 9.8 | 4.8 |
| 4.8% S) | | | | |
| Ti₃C₂T_{X} (14.6% N, | 700° C. | N₂ + 5% H₂ | 14.6 | 3.4 |
| 3.4% S) | | | | |

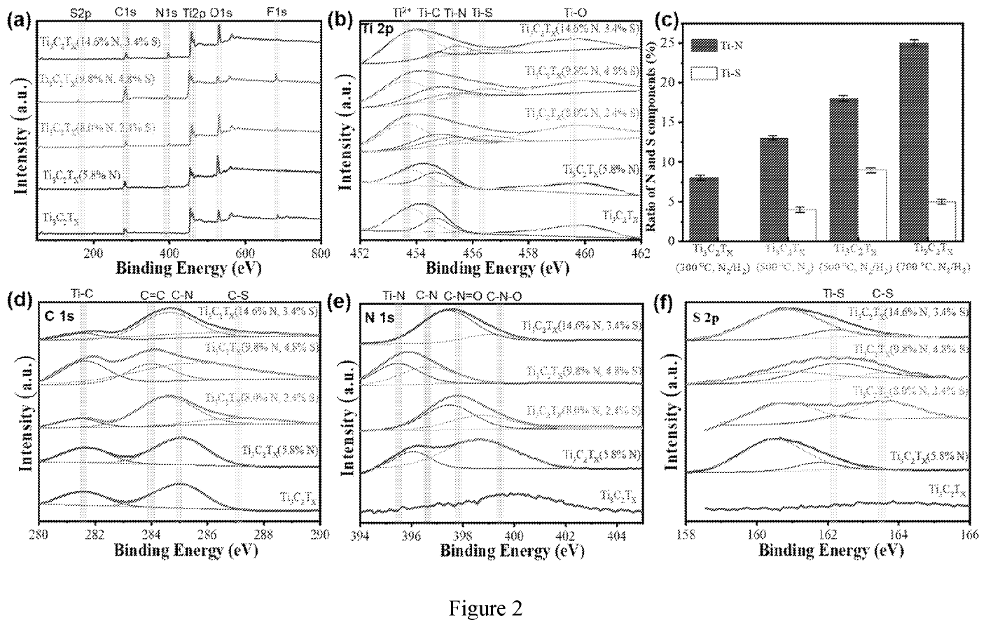

XPS survey spectra at binding energies from 0 to 800 eV were measured (FIG. 2a) to analyze the surface terminations of the co-doped MXenes. The survey spectra of pristine Ti₃C₂T_{X} showed mixed O- and F-terminations. Annealing with thiourea replaces F-terminations with N and/or S terminations resulted in a reduction of the F is signal, which followed from the lower stability of F-terminations. FIG. 2b shows de-convoluted Ti 2p core level spectra in all samples. In the Ti 2p result of pristine Ti₃C₂T_{X} (bottom), there were three main deconvoluted peaks in the ranges of 452 to 461 eV, which were assigned to be metallic Ti (453.7 eV (Ti 2p_{3/2})), Ti—C(454.4 eV (Ti 2p_{3/2})), and Ti—O (459.8 eV (Ti 2p_{3/2})). These peaks in pristine Ti₃C₂T_{X} were identical to those in previous reports. The Ti 2p_{3/2} peak components in the four different N—S-Ti₃C₂T_{X} co-doped with N and S showed broadening towards higher binding energy, confirming bond formation between Ti and N and S atoms. However, the relative intensity of Ti—O peak decreased, showing less oxygen content after N and S doping. It is also noted that the bonding ratio of Ti—N gradually increased, showing 8% (300° C. in N₂+5% H₂), 13% (500° C. in N₂), 18% (500° C. in N₂+5% H₂), and 25 (700° C. in N₂+5% H₂) as temperature increased from 300 to 700° C. Over this range, the bonding ratio of Ti—S increased 4% (500° C. in N₂) to 9% (500° C. in N₂+5% H₂), then decreased to 5% (700° C. in N₂+5% H₂) as temperature increased from 500 to 700° C. There was no Ti—S bonding observed in sample, which was annealed at 300° C. in N₂ atmosphere because S was not doped at that temperature (ratio of N and S binding is summarized in FIG. 2 (c)).

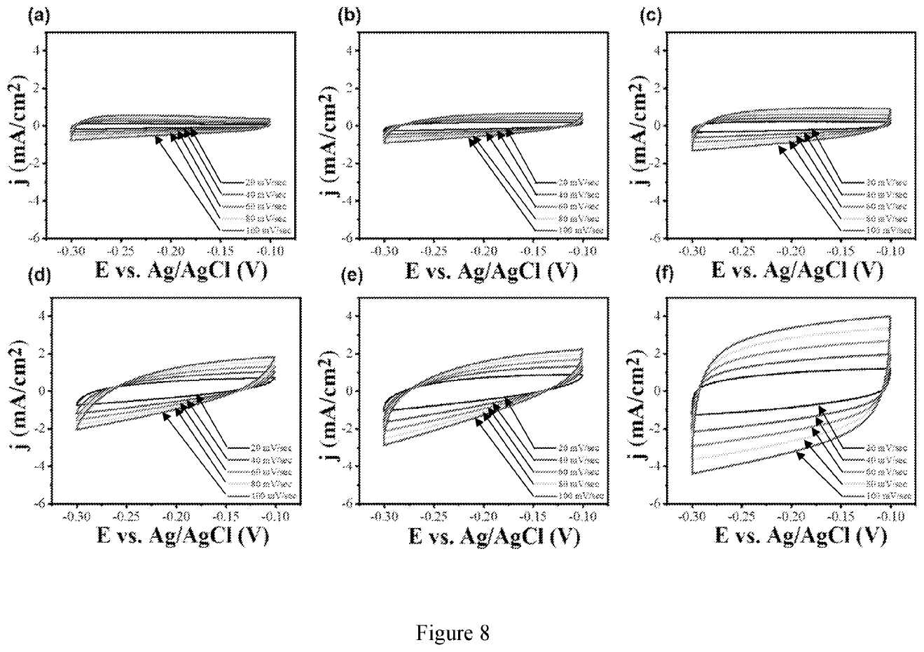

Furthermore, C bonding with Ti and incorporated N and S were confirmed by C is core spectra. FIG. 2 (d) shows the typical C is core level spectra of pristine-Ti₃C₂T_{X} (bottom), (Ti₃C₂T_{X} (5.8% N)), (Ti₃C₂T_{X} (8.0% N, 2.4% S)), Ti₃C₂T_{X} (9.8% N, 4.8% S), and Ti₃C₂T_{X} (14.6% N, 3.4% S) as a function of different co-doping temperatures, and all the C components such as C—Ti (281.7 eV), C—N (285.3 eV), C—S (287.0 eV), C═C (284.7 eV), and C—O/C—O—C (286.3 eV) were assigned. It was observed that the C—Ti (281.7 eV) bond was gradually diminished, while C═C (284.7 eV), C—N (285.3 eV) and C—S (287.0 eV) were increased as the reaction temperature was increased to 700° C. In particular, C—N bonds at 285.3 eV gradually increased further as the reaction temperature was increased to 700° C., while C—S bonds at 287.0 eV were decreased at 700° C. annealed sample. Similar to Ti—S bonds, sample, which is annealed at 500° C. in N₂+5% H₂ had the highest C—S bond percentage among all samples, showing that 500° C. is the optimal annealing condition to produce sufficient S doping. Moreover, similar to Ti—N and T-S bonding ratios, C—N bonding ratios gradually increased, showing 6% (300° C. in N₂+5% H₂), 7% (500° C. in N₂), 11% (500° C. in N₂+5% H₂), and 14% (700° C. in N₂+5% H₂) as temperature increased from 300 to 700° C., however, the bonding ratio of C—S increased 2% (500° C. in N₂) to 6% (500° C. in N₂+5% H₂), then decreased to 1% (700° C. in N₂+5% H₂) as temperature increased from 500 to 700° C. (ratio of N and S binding with C is summarized in FIG. 8). Furthermore, FIG. 2e shows the N is core level spectra to describe the N-doping and chemical bonds in the N—S-Ti₃C₂T_{X}. A nitrogen peak was not observed for pristine Ti₃C₂T_{X} (bottom in FIG. 2e). After heat treatment at 300° C. in N₂+5% H₂, visible peaks of N is were observed, which can be assigned to Ti—N at 396.9 eV, and a prominent peak of N—C—O at 400 eV. These confirmed Ti—N bond formation at 300° C. but not C—N bonds because reactivity of NH₃ is low at lower temperatures. At a higher reaction temperature of 500° C., there was greater formation of N—C chemical bonds in the Ti₃C₂T_{X} but less bond formation between Ti and N. It was observed that reaction with N₂ in the forming gas (N₂+5% H₂) atmosphere at 500° C. produced optimized C—N and Ti—N bonds together. However, reaction at 700° C. produced highest C—N but the least Ti—N bonding. Similar to nitrogen core level spectra, S 2p core level spectra describe the S-doping and chemical bonds in the N—S-Ti₃C₂T_{X} (shown in FIG. 2f). It was observed that optimum Ti—S and C—S bonds were formed at 500° C. in N₂+5% H₂ atmosphere. However, at high temperatures of 700° C., fewer C—S and Ti—S bonds were formed, which suggested higher surface oxidation of Ti₃C₂T_{X} at high temperature restricted the Ti—S and C—S bond formation. The lower formation of Ti—S and C—S bonds may have occurred due to unstable chemical bonds of S on the surface of Ti₃C₂T_{X}. In summary, the core spectra showed that the concentration of Ti—N, Ti—S, C—N and C—S bonds were optimal and that they simultaneously existed in sample, which was produced by annealing at 500° C. in a forming gas (N₂+5% H₂) atmosphere. The simultaneous existence of Ti—N, Ti—S, C—N and C—S bonds would play an important role of attenuating the strength of H-binding at active sites for HER. These results indicate that the optimum reaction temperature for effective N and S co-doping is around or is 500° C.

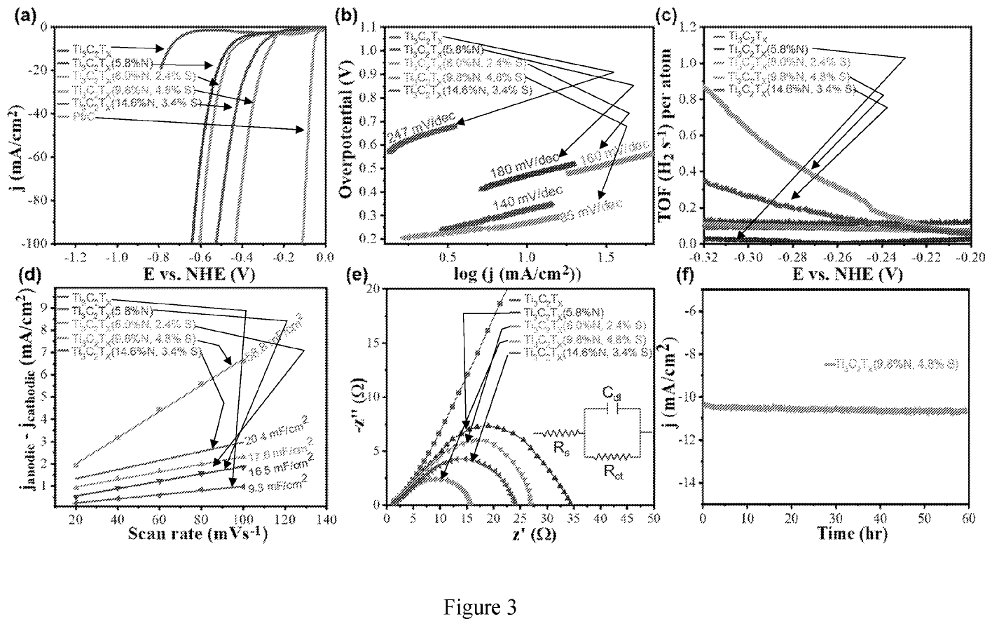

Electrocatalytic Performance for HER. The electrocatalytic performance for HER of the as-synthesized co-doped Ti₃C₂T_{X} were tested in 0.5 M H₂SO₄ electrolyte using a typical three-electrode system. First, the HER activity of the different samples was estimated by comparing the linear sweep voltammetry (LSV) curves obtained at a rate of 10 mV/sec. All potentials are referenced to the normal hydrogen electrode (NHE). FIG. 3a shows the LSV curves of the pristine Ti₃C₂T_{X} as well as N—S-co-doped Ti₃C₂T_{X} compared with commercially available Pt/C. Among all as-synthesized samples, the N—S-co-doped Ti₃C₂T_{X} annealed at 500° C. in N₂+5% H₂ atmosphere exhibited the lowest overpotential (260 mV) for achieving 10 mA/cm⁻² current density. This overpotential was three times lower than that of pristine-Ti₃C₂T_{X} and it outperforms previous reports of titanium and molybdenum based MXenes (e.g., Ti₂CT_{X}, Mo₂CT_{X}, etc.). The additional samples with controlled N and S incorporation, formed at 300° C. and 700° C., showed a trend closely corresponding to the bonding concentration of N and S observed by XPS (overpotential values are listed in Table 2). As shown in FIG. 3a, the overpotentials gradually decrease with respect to the pristine-Ti₃C₂T_{X}. However, the control experiment confirmed that the sample treated at higher temperature (700° C. in N₂+5% H₂) with a very low percentage of S bonds with Ti and C showed an increased overpotential. This confirmed the hypothesis that both N and S bonds with Ti and C are required to improve the electrocatalytic activity. Similar behavior was observed in lower temperature (300° C.) treated samples (having only N bonding with Ti, and C). It can be expected that N-doping alone would not be sufficient to activate and/or increase the electrocatalytic active sites, resulting in low performance. In addition, surface modification by interfacial bonding with N and S ensured the high coverage of active sites for electrocatalytic activity.

The HER kinetics of these catalysts were analyzed based on the Tafel slope, turn over frequency (TOF), electrochemical reactive surface area (ECSA), and charge transfer resistance (R_{ct}). The Tafel slopes were calculated as 247 mV/dec for pristine-Ti₃C₂T_{X}, decreasing progressively for samples with higher N—S doping, to a lowest value of 85 mV/dec for the Ti₃C₂T_{X} annealed at 500° C. in N₂+5% H₂ atmosphere as shown in FIG. 3b. The smallest Tafel slope of the optimally co-doped Ti₃C₂T_{X} was interpreted to mean that facile HER kinetics was promoted by N and S incorporation with the Volmer-Heyrovsky step as the rate-determining step. To further understand the intrinsic electrocatalytic activity, the overall turnover frequencies (TOFs) per surface site were quantified. FIG. 3c indicates the TOF value of the optimal co-doped Ti₃C₂T_{X} is 0.63 s⁻¹ at an overpotential of 300 mV, which is the highest among as-synthesized samples (8 times higher than pristine Ti₃C₂T_{X}) and higher than that of reported Mxene electrodes. The higher TOF values are in full agreement with the intrinsic catalytic activity for the HER, suggesting that the greatly enhanced HER activity of the co-doped Mxene mainly benefited from N and S incorporation into Ti₃C₂T_{X}.

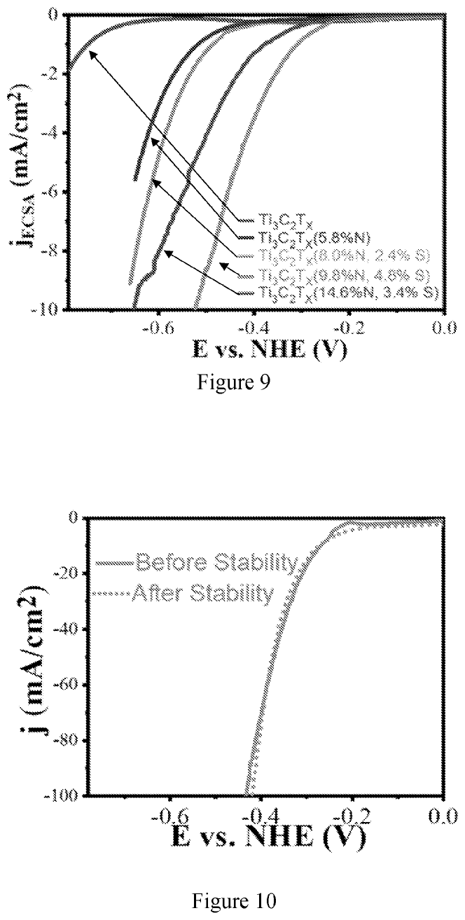

To provide insight into as-synthesized samples, ECSA was calculated by using electrochemical double layer capacitive (C_{dl}) measurements (cyclic voltammetry to calculate (C_{dl}) are shown in supporting information FIG. 9). As shown in FIG. 3d, the ECSA of the pristine-Ti₃C₂T_{X}, Ti₃C₂T_{X} (0.7% N), Ti₃C₂T_{X} (5.8% N), Ti₃C₂T_{X} (8.0% N, 2.4% S), Ti₃C₂T_{X} (9.8% N, 4.8% S) and, Ti₃C₂T_{X} (14.6% N, 3.4% S) were calculated to be 9.3 mF/cm², 9.7 mF/cm², 16.5 mF/cm², 17.6 mF/cm², 17.6 mF/cm², 58.8 mF/cm², and 20.4 mF/cm², respectively. Notably, the highest ECSA of the N—S-Ti₃C₂T_{X} (6 times higher than pristine-Ti₃C₂T_{X}) is attributed to anion incorporation, which resulted in high electrocatalytic activity. To gain insight into the kinetics of the electrocatalytic activity of MXene, the LSV curves were normalized by the ECSA (as shown in FIG. 10). According to LSV curves expressed in j_{ECSA}, Ti₃C₂T_{X} (9.8% N, 4.8% S) exhibited better ECSA-normalized activity than other as-synthesized samples, which indicates the intrinsic activity of Ti₃C₂T_{X} is increased after N and S co-doping.

TABLE 2
Electrocatalytic behavior of pristine and doped
Ti₃C₂T_{X} samples as a function of anion incorporation.

| | | Tafel | | | |
|---|---|---|---|---|---|
| | Over- | Slope | TOF at | | C_{dl} |
| | potential | [mV · | 300 mV | R_{ct} | [mF · |
| Sample | [mV] | dec⁻¹] | [H₂S⁻¹] | [Ω] | cm⁻²] |
| Ti₃C₂T_{X} (0.7% N) | 590 | 215 | 0.07 | 41 | 9.7 |
| Ti₃C₂T_{X} (5.8% N) | 460 | 180 | 0.09 | 32 | 16.5 |
| Ti₃C₂T_{X} (8.0% N, | 430 | 160 | 0.12 | 25 | 17.6 |
| 2.4% S) | | | | | |
| Ti₃C₂T_{X} (9.8% N, | 260 | 85 | 0.64 | 14 | 58.8 |
| 4.8% S) | | | | | |
| Ti₃C₂T_{X} (14.6% N, | 320 | 140 | 0.26 | 22 | 20.4 |
| 3.4% S) | | | | | |
| Ti₃C₂T_{X} | 750 | 247 | 0.08 | 160 | 9.3 |

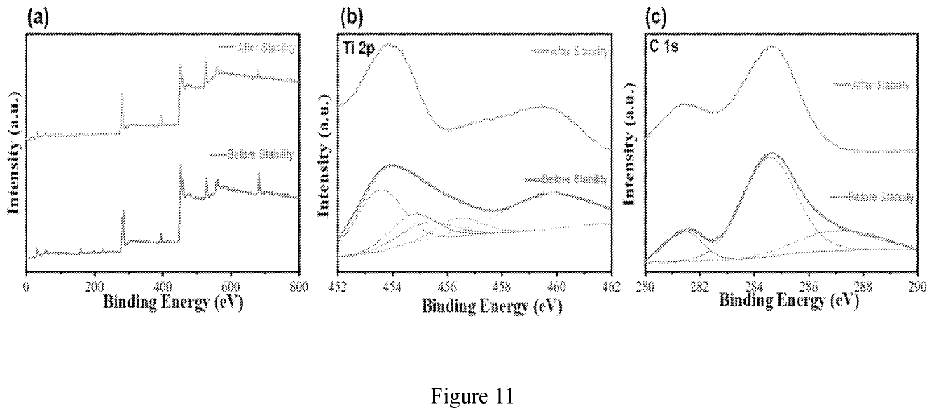

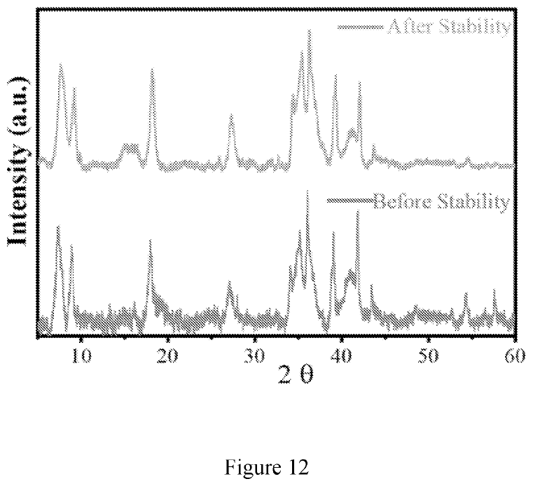

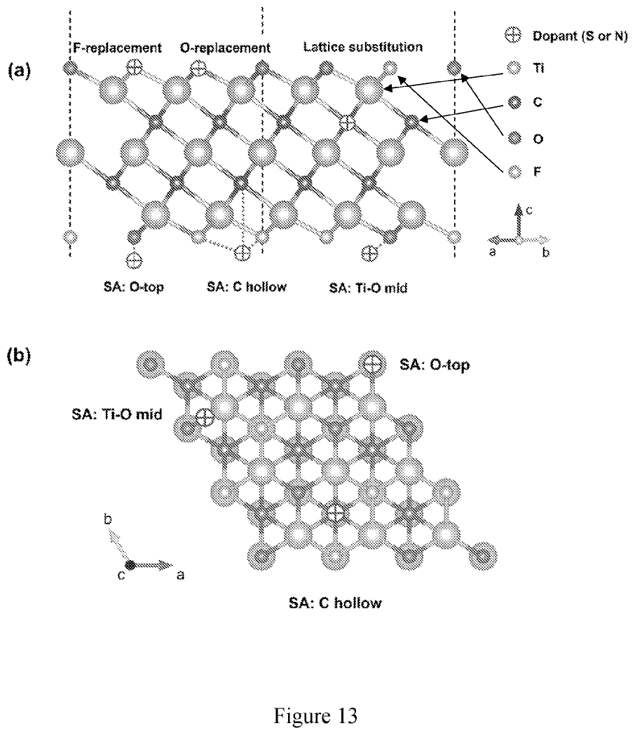

The enhanced electrocatalytic activity after anion incorporation and the kinetics of the electrocatalytic reaction were characterized by calculating the charge transfer resistance (R_{ct}) using electrochemical impedance spectroscopy (EIS) measurements at an overpotential of 275 mV vs. NHE, as shown in FIG. 3e. It was observed that the R_{ct} decreased notably from 160Ω for pristine-Ti₃C₂T_{X} to 41Ω (Ti₃C₂T_{X} (0.7% N)), 32Ω (Ti₃C₂T_{X} (5.8% N)), 25Ω (Ti₃C₂T_{X} (8.0% N, 2.4% S)), 14Ω (Ti₃C₂T_{X} (9.8% N, 4.8% S)) and, 22Ω (Ti₃C₂T_{X} (14.6% N, 3.4% S)), respectively. It was observed that the R_{ct} value of the optimally co-doped Ti₃C₂T_{X} sample is comparable to the state of art noble metal decorated MXene, and 5 times lower than reported doped MXene. The lowest R_{ct} value of the optimally co-doped Ti₃C₂T_{X} (12 times lower than that of pristine-Ti₃C₂T_{X}) sample suggested faster electron transport and charge transfer kinetics after anion incorporation, originated from the high electron affinity of N and S bonds with Ti and C. The electrocatalytic and kinetic parameter values of pristine and co-doped Ti₃C₂T_{X} are listed in Table 2. Importantly, in addition to the superior HER activity, after anion incorporation the N—S-co-doped Ti₃C₂T_{X} showed outstanding stability, exhibiting no activity decay at all during a chronoamperometry test up to 60 hours, operated at 260 mV, shown in FIG. 3f. Moreover, after a long term stability test of 60 h, the overpotential value needed to achieve 10 mA/cm² only increased by 5 mV in the LSV measurements of HER (shown in FIG. 11), indicating the superb durability of the optimal co-doped MXene in acidic solutions. In addition, chronoamperometry results indicated no decay in current density for 60 hours, which is 5 times higher than reported stability time (12 hours). To determine the chemical and structural durability of co-doped Ti₃C₂T_{X} in acidic medium, XPS, and XRD were conducted after the electrochemical stability tests. The XPS results confirmed that there were no significant changes in the chemical states of the optimally co-doped Ti₃C₂T_{X} MXene (shown in FIG. 12), revealing, tunable N and S co-doping with chemical structure modification with formation of Ti—S and Ti—N bonds help to prevent oxidation/corrosion of transition metal surface and resolve the stability issues in acidic electrolyte. Moreover, phase stability is confirmed by XRD analysis, where the major peaks corresponding to Ti₃C₂T_{X} MXene are clearly still present after the electrochemical tests (shown in FIG. 12).

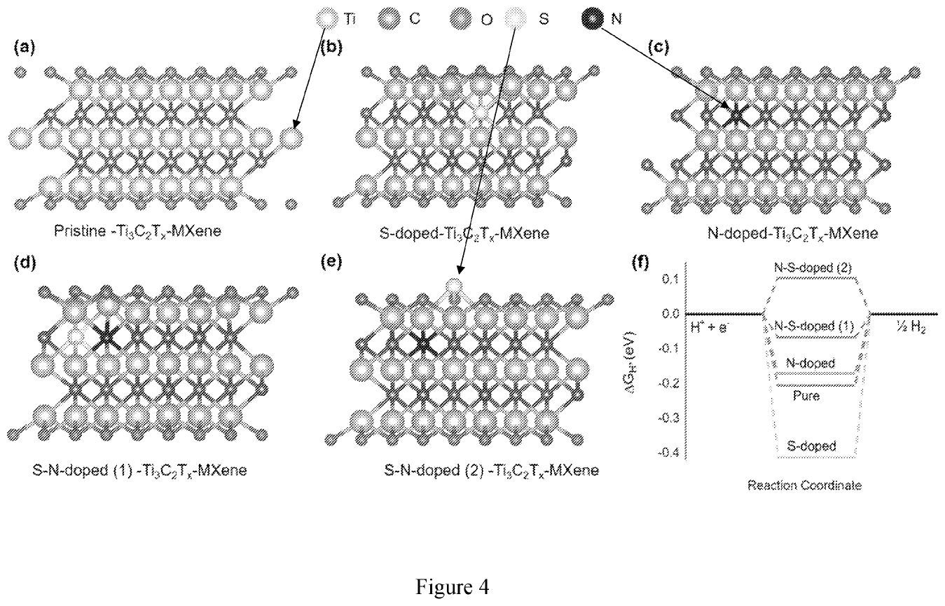

Interpretation of the Active sites for Electrocatalysis: DFT Calculations. To understand the high activity of the co-doped N—S-Ti₃C₂T_{X} as HER electrocatalysts, density functional theory (DFT) calculations were performed on model systems. To determine dopant positions, formation energies of all possible configurations for both N- and S-dopants were computed Lattice substitution for carbon, functional group substitution for both F— and O—, and surface adsorption were considered as possible dopant locations. Nitrogen favorably forms as a lattice substitution for carbon, consistent with known values. Sulfur substitutes both for carbon in the lattice and for functional groups. Previous work has modeled sulfur as functionalized on oxygen, however, this configuration was not found to be energetically favorable, N—S-doped MXene with adjacent dopants were compared to the formation energy of infinitely spaced dopants. The optimized molecular structures from the DFT calculations of the lowest energy dopant configurations are shown in FIG. 4a-4e.

The Gibbs free energy of hydrogen adsorption (ΔG_{H*}) is widely considered as a descriptor of HER activity. The ideal catalyst will have a Gibbs free energy per H* (ΔG_{H*}) equal to zero. HER adsorption on Ti₃C₂T_{X} MXene is modelled as occurring on O-terminations, as is common practice. ΔG_{H*} is calculated from the energy required to add or remove one hydrogen from the surface. The computed Gibbs free energy per H* (ΔG_{H*}) with N and S incorporation are presented in FIG. 4f. Ti₃C₂T_{X}-H, S—Ti₃C₂T_{X}-H, and N-Ti₃C₂T_{X}-H possess negative ΔG_{H*} values of −0.21, −0.41, and −0.17 eV. Both favorable configurations for N—S-doped Ti₃C₂T_{X} are shown, possessing ΔG_{H*} values of −0.07 and +0.11 eV. The large negative ΔG_{H*} of pristine Ti₃C₂T_{X} corresponds to overly strong H-binding, limiting the HER kinetics and resulting in slower electrocatalytic activity, which matches well with the experimental results. The N-doped Ti₃C₂T_{X} has ΔG_{H*} closer to zero than pure Ti₃C₂T_{X}, exhibiting improved catalytic activity, consistent with experiments and previous DFT results. N and S bonding with Ti and C in co-doped Ti₃C₂T_{X} shows a smaller ΔG_{H*} value than pure and single-doped in both configurations, of +0.11 and −0.07 eV, which is very close to zero. The electrocatalyst with the best HER performance should theoretically have a near zero ΔG_{H*} per H atom, thus, the bond formation of N and S together with Ti and C in the co-doped Ti₃C₂T_{X} sample is favorable for fast HER kinetics. Incorporation of just N or S alone in Ti₃C₂T_{X} results in higher ΔG_{H*} per H atom, showing N and S synergistically improve the electrocatalytic behavior of Ti₃C₂T_{X}.

In summary, as described herein Ti₃C₂T_{X} MXene was transformed into an active and highly stable electrocatalyst for HER by in-situ interfacial co-doping and structural modifications. These N—S-doped Ti₃C₂T_{X} electrocatalysts were synthesized by a simple but effective annealing process using thiourea. The optimal co-doped Ti₃C₂T_{X} sample contained Ti—S, Ti—N, C—N, and C—S bonds on its surface, resulting in a change in surface morphology from flat nanosheets to hexagonal nanoplate-decorated nanosheets. The anion (N and S) incorporation of Ti₃C₂T_{X} enhanced the kinetics for HER activity, showing superior performance in terms of overpotential (260 mV) and Tafel slope (85 mV/dec), which were three times lower than those of pristine Ti₃C₂T_{X} (overpotential: 770 mV, and Tafel slope: 247 mV/dec). Another result of the approach described herein is that the co-doped Ti₃C₂T_{X} catalysts exhibited desirable stability, up to 60 hours without any activity degradation, which has importance for practical applications for future energy devices. Computational results confirmed that together N and S bonds in Ti₃C₂T_{X} act as active sites, promoting H* adsorption/desorption and improving HER kinetics. This concept, producing an activated anion incorporated-MXene-based material with interfacial chemical bonds of Ti—S, Ti—N, C—N, and C—S, provided a promising route to prepare efficient and cost effective noble-metal-free electrocatalysts for large scale hydrogen production.

Synthesis of Pristine-Ti₃C₂T_{X} (MXene Phase). 1 g of Ti₃AlC₂ powder (200 mesh) was immersed in mixture of 47-49% concentrated HF (3 ml), 47-49% concentrated 47% HCl (6 ml) and DI water (1 ml) solution and stirred for 24 hours at room temperature. After treatment, the resulting solution was washed with deionized water to make it's pH 7, and separate the settled powders by centrifugation. The settled powder were dried in a vacuum furnace at 60° C. For exfoliation the 8 M LiCl₆ was added with DI water in the ratio of 7:3 in MXene solution and stirred for 4 hours. After that the LiCl₆ was washed by deionized water, and centrifuged to separate the nanosheets from supernatants.

Synthesis of N and S co-doped Ti₃C₂T_{X}. N and S co-doped Ti₃C₂T_{X} were synthesized by the reaction of pristine-Ti₃C₂T_{X} with thiourea under the N₂, and N₂+5% H₂ condition. In a synthesis, 100 mg of pristine-Ti₃C₂T_{X} was mixed with 260 mg of thiourea. The homogeneously mixed powder was placed in alumina boat for annealing in tube furnace. The obtained samples were heated under N₂, and N₂+5% H₂ flow at 300, 500, and 700° C. at a heating rate of 3° C./min, respectively. These annealing conditions were maintained for 3 hours to allow the reaction to complete. Finally, N and S co-doped Ti₃C₂T_{X} samples were collected.

Chemical and Microstructural Characterizations. The chemical, morphology, and microstructures, of as-synthesized samples were investigated by X-ray photospectroscopy (XPS), powder X-ray diffraction (XRD), transmission electron microscope (TEM), field-emission scanning electron microscope (FESEM), and atomic force microscopy (AFM).

Electrochemical Characterization. Firstly, 4 mg of the as-synthesized samples were homogeneously mixed in a solution containing 660 μL of DI water, 220 μL of ethanol, and 80 μL of a Nafion 117 solution by ultra-sonication. Then, 3 μL of the as-prepared mixture was dropcast on a glassy carbon electrode (diameter=3 mm). Electrochemical analyses were performed by VersaSTAT 3 (principle applied research) electrochemical workstation with a three-electrode systems (working electrode was as-prepared samples on glassy carbon electrode, the reference electrode was Ag/AgCl in 3M KCl, and the counter electrode was a Pt mesh) in 0.5 M H₂SO₄ electrolyte.

Computational Methods. First principles DFT calculations were performed using the Vienna ab initio simulation package (VASP) and the projector-augmented wave method. The Perdew-Burke-Ernzerhof (PBE) exchange-correlation functional was used. The plane-wave cutoff energy was set to 520 eV. A gamma-centered grid of 6×6×1 k-points was used to sample the Brillouin zone. The MXene monolayer was modeled as a 3×3×1 supercell with a vacuum space of 20 Å included to avoid spurious interactions. All structural relaxations were optimized to a convergence threshold of 10⁻⁶ eV for total energy and 10⁻² eV/A for atomic forces. Zero-point energy and entropy corrections were used in constructing reaction free energies.

TABLE 3
All dopant formation energies and Gibbs free
energy of hydrogen adsorptions computed.
Pure Ti3C2Tx

| | ΔG_{H}* |
|---|---|
| Termination | (eV) |
| un-terminated | +0.36 |
| O-terminated | −0.21 |
| F-terminated | +2.46 |

| | | |
|---|---|---|
| | Dopant formation | ΔG_{H}* |
| Dopant location | energy (eV) | (eV) |

N-doped Ti3C2Tx

| | | |
|---|---|---|
| O-replacement | +1.06 | −0.97 |
| F-replacement | +3.39 | |
| Surface Adsorb - O top | +4.03 | |
| Surface Adsorb - C hollow | +5.14 | |
| Surface Adsorb - Ti—O mid | +5.80 | |
| Lattice substitution | −2.16 | −0.17 |

S-doped Ti3C2Tx

| | | |
|---|---|---|
| O-replacement | −0.02 | −0.41 |
| F-replacement | +2.41 | |
| Surface Adsorb - O top | +2.11 | |
| Surface Adsorb - C hollow | +3.21 | |
| Surface Adsorb - Ti—O mid | +3.07 | |
| Lattice substitution | −0.82 | −0.51 |

N-S-doped Ti3C2Tx

| | | | Dopant favorability |
|---|---|---|---|
| | Dopant formation | ΔG_{H}* | of being adjacent |
| Dopant locations | energy (eV) | (eV) | (eV) |
| Both as terminations | +1.94 | | +0.71 |
| Both lattice substituted | −2.86 | −0.07 | +0.12 |
| N lattice substitution, | −2.14 | +0.11 | +0.03 |
| S - termination | | | |
| N-termination, S lattice | −0.23 | +0.25 | +0.59 |
| substitution | | | |

Although the present disclosure has been described with respect to one or more particular embodiments and/or examples, it will be understood that other embodiments and/or examples of the present disclosure may be made without departing from the scope of the present disclosure.

1. A MXene composition, comprising: a MXene with a formula of M₃C₂Tₓ, wherein M is a metal or metal alloy and T is a surface termination group chosen from —O, —OH, —F, —I, and —Cl, and, wherein at least a portion of M and C atoms are bonded to S or N and the amount of S is at least 1% and the amount of N is at least 5%, wherein the percent S and percent N are relative to the total percentage of atoms in the atoms in the MXene.

2. The MXene composition according to claim 1, wherein M is Ti, Nb, W, Y, Zr, Hf, Mo, V, TiV, MoV, NbTi, NbZr, MoTi, or any combination thereof.

3. The MXene composition according to claim 2, wherein M is Ti.

4. The MXene composition according to claim 1, wherein the bonded S is 1-7% of the atoms in the MXene.

5. The MXene composition according to claim 4, wherein the bonded S is 2-4% of the atoms in the MXene.

6. The MXene composition according to claim 1, wherein the bonded N is 5-25% of the atoms in the MXene.

7. The MXene composition according to claim 6, wherein the bonded N is 5-15% of the atoms in the MXene.

8. The MXene composition according to claim 1, wherein the MXene has a surface comprising a hexagonal-nanoplate-decorated nanosheet morphology.

9. The MXene composition according to claim 1, wherein the bonded S and N are located in the basal plane of the MXene.

10. A device comprising a MXene composition according to claim 1.

11. The device according to claim 10, wherein the device is an energy storage device.

12. The device according to claim 11, wherein the device is a battery, supercapacitor, or fuel cell.

13. The device according to claim 10, wherein the device is an electrode or comprises an electrode.

14. The device according to claim 10, wherein the device is a sensor.

15. A method of making a MXene composition according to claim 1, comprising exposing an unmodified MXene with a formula of M₃C₂Tₓ to a sulfur source and a nitrogen source at a temperature of 300 to 700° C.

16. The method according to claim 15, further comprising subjecting the MXene composition to a flow comprising nitrogen gas and hydrogen gas.

17. The method according to claim 15, wherein the sulfur source and the nitrogen source are the same.

18. The method according to claim 15, wherein the sulfur source and the nitrogen source are organosulfur compounds.

19. The method according to claim 18, wherein the organosulfur compound is chosen from a thiourea, a thiol, or a thione.

20. The method according to claim 18, wherein the thiourea is thiourea.
